(19) United States
(12) Patent Application Publication
(10) Pub. No.: US 2014/0012536 A1
(43) Pub. Date: Jan. 9, 2014

(54) INFORMATION PROCESSING APPARATUS, INFORMATION PROCESSING METHOD, PROGRAM, AND RECORDING MEDIUM

(71) Applicant: Tomohisa Takaoka, Kanagawa (JP)

(72) Inventor: Tomohisa Takaoka, Kanagawa (JP)

(73) Assignee: SONY CORPORATION, Minato-ku (JP)

(21) Appl. No.: 14/006,581

(22) PCT Filed: Feb. 21, 2012
(86) PCT No.: PCT/JP12/54131

§ 371 Date: Sep. 20, 2013

(30) Foreign Application Priority Data
Mar. 31, 2011 (JP) 2011-078316

(51) Int. Cl. G01P 3/00

(52) U.S. Cl. CPC G01P 3/00
USPC 702/142

(57) ABSTRACT

Provided is an information processing apparatus including an acquisition unit configured to acquire a pitch of walking from oscillation detection data, and a determination unit configured to determine whether or not a user is moving at a velocity faster than normal based on a difference between the pitch acquired by the acquisition unit and a pitch during normal walking which is calculated based on the oscillation detection data of a past.

### TECHNICAL FIELD

The present disclosure relates to an information processing apparatus, an information processing method, a program, and a recording medium, and more particularly relates to an information processing apparatus, an information processing method, a program, and a recording medium that determine the state of a user.

### BACKGROUND ART

A walking state of a user is important information which influences the action of the user. For example, Patent Literature 1 discloses a method for calculating a moving velocity from a position information history and determining a movement means of the user based on magnitude of the moving velocity.

### CITATION LIST

### Patent Literature

Patent Literature 1: JP 2007-304009A

### SUMMARY OF INVENTION

### Technical Problem

However, an action of a user who is walking in a normal state is different from an action of the same user who is moving at a velocity higher than normal, even though the user moves on foot in both the cases.

In view of the above-stated circumstances, it is desirable to determine change in state when the user is moving on foot.

### Solution to Problem

According to an embodiment of the present disclosure, there is provided an information processing apparatus including an acquisition unit configured to acquire a pitch of walking from oscillation detection data, and a determination unit configured to determine whether or not a user is moving at a velocity faster than normal based on a difference between the pitch acquired by the acquisition unit and a pitch during normal walking which is calculated based on the oscillation detection data of a past.

Further, according to an embodiment of the present disclosure, there is provided an information processing method including acquiring a pitch of walking from oscillation detection data, and determining whether or not a user is moving at a velocity faster than normal based on a difference between the acquired pitch and a pitch during normal walking which is calculated based on the oscillation detection data of a past.

Further, according to an embodiment of the present disclosure, there is provided a program for causing a computer to function as an information processing apparatus, the information processing apparatus including an acquisition unit configured to acquire a pitch of walking from oscillation detection data, and a determination unit configured to determine whether or not a user is moving at a velocity faster than normal based on a difference between the pitch acquired by the acquisition unit and a pitch during normal walking which is calculated based on the oscillation detection data of a past.

According to an embodiment of the present disclosure, there is provided a computer readable recording medium for having a program thereon, the program causing a computer to function as an information processing apparatus that includes an acquisition unit configured to acquire a pitch of walking from oscillation detection data, and a determination unit configured to determine whether or not a user is moving at a velocity faster than normal based on a difference between the pitch acquired by the acquisition unit and a pitch during normal walking which is calculated based on the oscillation detection data of a past.

### Advantageous Effects of Invention

As explained above, according to the present disclosure, change in the state when a user is moving on foot can be determined.

### BRIEF DESCRIPTION OF DRAWINGS

FIG. 1 is a function configuration view of a terminal apparatus according to one embodiment of the present disclosure.

FIG. 2 is a block diagram showing a configuration example of a position information acquisition unit of the terminal apparatus according to the embodiment.

FIG. 3 is a hardware configuration view of the terminal apparatus according to the embodiment.

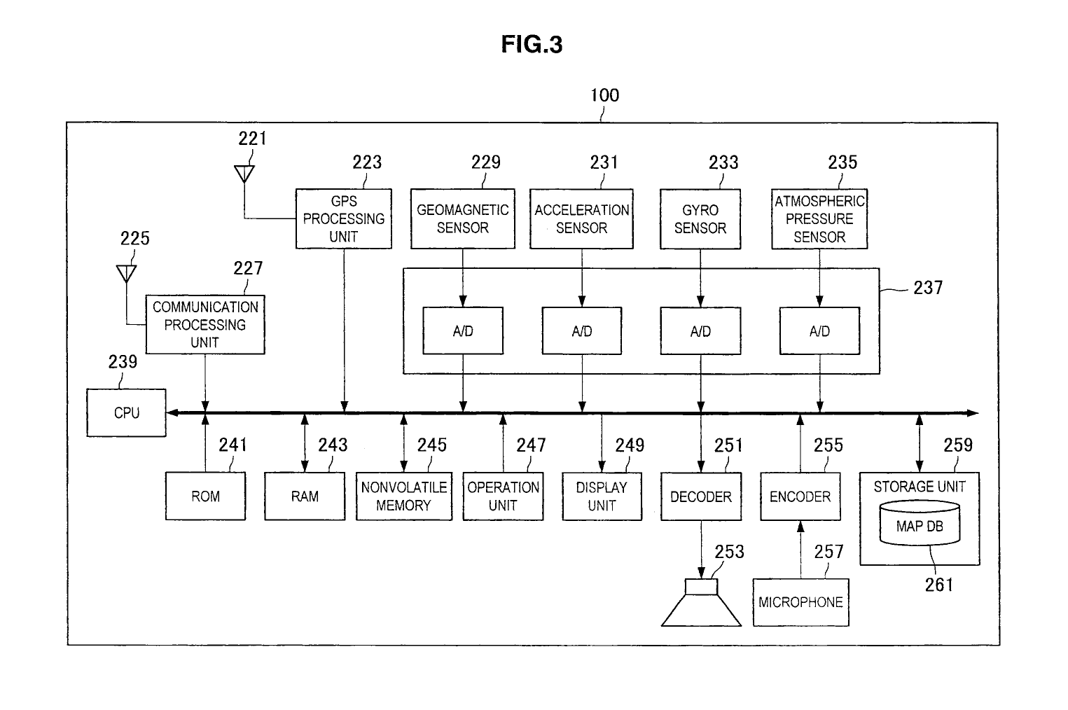

FIG. 4 is a graph view showing an example of oscillation detection data (detected by an acceleration sensor) at a normal time when the terminal apparatus is put in a pocket and carried around.

FIG. 5 is a graph view showing an example of oscillation detection data (detected by an acceleration sensor) at a normal time when the terminal apparatus is held by hand and carried around.

FIG. 6 is a graph view showing an example of oscillation detection data (detected by an acceleration sensor) at a congested time.

FIG. 7 is a graph view showing an example of oscillation detection data (detected by a gyro sensor) at a normal time when the terminal apparatus is placed on the waist.

FIG. 8 is a graph view showing an example of oscillation detection data (detected by a gyro sensor) at a normal time when the terminal apparatus is put in a pocket and carried around.

FIG. 9 is a graph view showing an example of oscillation detection data (detected by a gyro sensor) at a normal time when the terminal apparatus is held by hand and carried around.

FIG. 10 is a flow chart showing operation of the terminal apparatus according to the embodiment.

FIG. 11 is a flow chart showing a flow of speedup determination processing of the terminal apparatus according to the embodiment.

### DESCRIPTION OF EMBODIMENTS

Hereinafter, preferred embodiments of the present technology will be described in detail with reference to the appended drawings. Note that, in this specification and the drawings, elements that have substantially the same function and structure are denoted with the same reference signs, and repeated explanation is omitted.

Note that a description will be given in the order shown as shown below:

1. Outline

2. Function configuration example

3. Hardware configuration example

4. Oscillation detection data

5. Operation example

### 1. Outline

A description is first given of the outline of a state determination method according to one embodiment of the present disclosure. The state determination method according to the present embodiment determines whether or not each user is moving at a velocity faster than normal based on oscillation detection data acquired by a terminal apparatus carried by each user. In this case, it can be presumed that a user moves at a velocity faster than normal when the user is in the state of jogging and in the state of being in a hurry. The information necessary for user when the user is in a normal walking state is different from the information necessary when the user is moving at a velocity faster than normal. Accordingly, the state of the user is important information which influences the action of the user.

For example, a method involving use of the moving velocity of a user may be considered as the method for determining the state of the user. However, with this method, it has been difficult to distinguish, with sufficient precision, the user in the state of being in a hurry from the user in the state of jogging. It is also difficult to distinguish, based on moving velocity, between moving with a moving walk, moving with an escalator, moving by bicycle, and moving by car. For example, if a person is jogging at the same velocity as a person riding on a moving walk, it is impossible to distinguish one person from the other based on the moving velocity.

Accordingly, the state determination method according to one embodiment of the present disclosure determines whether or not a user is moving at a velocity faster than normal based on oscillation detection data acquired by a terminal apparatus carried by the user. The oscillation detection data is acquired by a sensor (such as an acceleration sensor, a gyro sensor, and an atmospheric pressure sensor) mounted on the terminal apparatus so as to be able to detect oscillation.

Pitches of a user at a normal time, in a hurry, and during jogging are different from each other. The pitch at a normal state is slower than that in a hurry or during jogging. Amplitudes at a normal state, in a hurry and during jogging are also different from each other. An embodiment of the terminal apparatus of the present disclosure which uses these differences to determine the state of the user will be described below.

### 2. Function Configuration Example

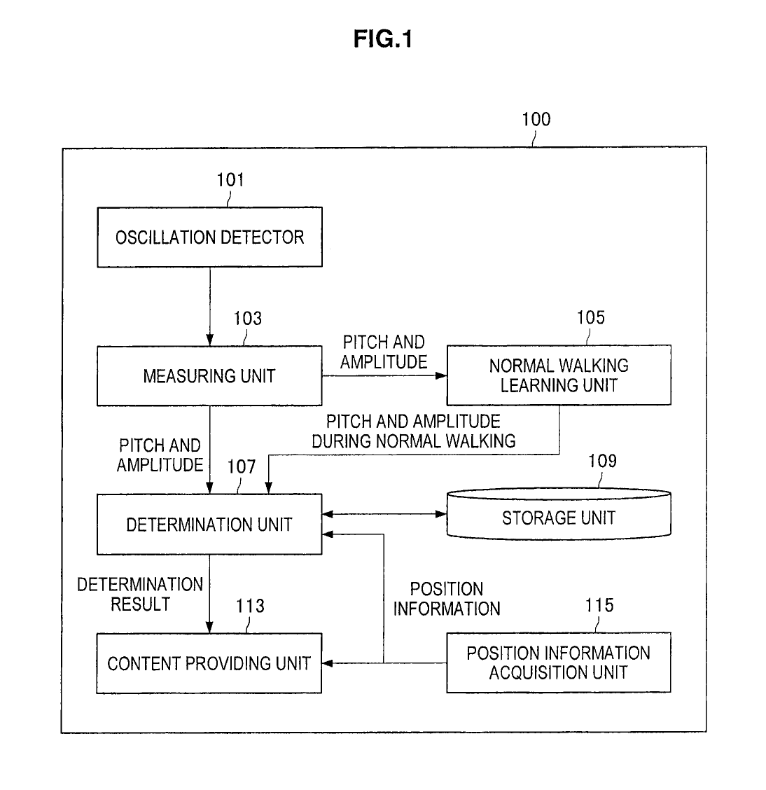

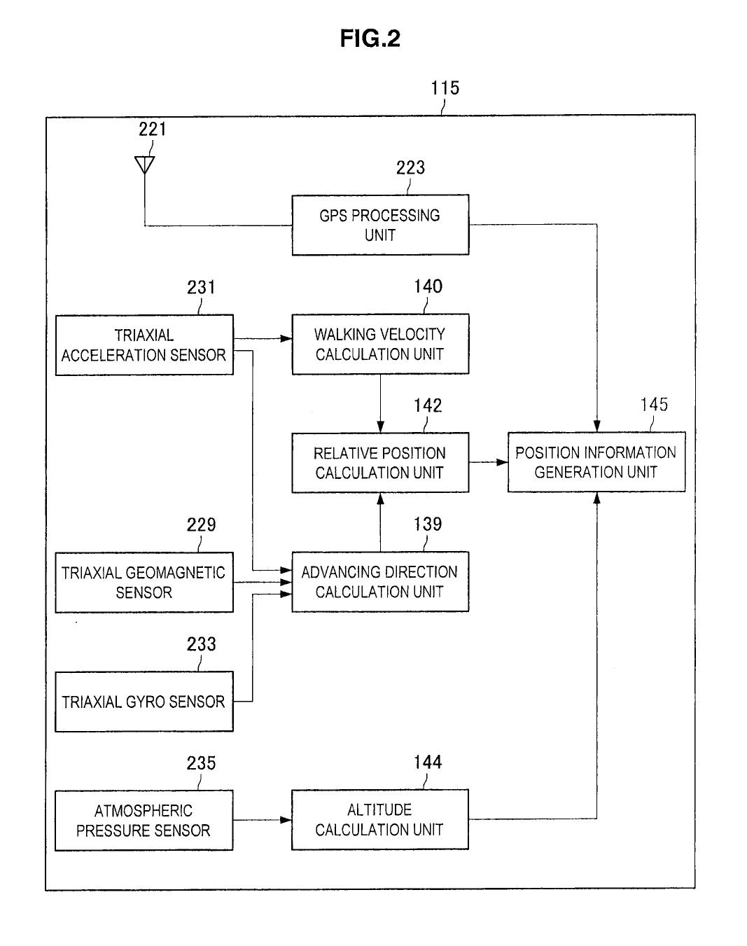

The configuration of a terminal apparatus 100 as an example of a state determination apparatus according to a first embodiment of the present disclosure will be described with reference to FIGS. 1 and 2. FIG. 1 is a function configuration view of the terminal apparatus according to one embodiment of the present disclosure. FIG. 2 is a block diagram showing a configuration example of a position information acquisition unit of the terminal apparatus according to one embodiment of the present disclosure.

The terminal apparatus 100 is an example of a state determination apparatus that determines the state of a user. The terminal apparatus 100 may be an information processing apparatus such as a mobile phone, a notebook personal computer (PC), a personal navigation device (PND), a portable music reproduction device, a portable image processing device, and a portable game machine. With reference to FIG. 1, the terminal apparatus 100 mainly includes an oscillation detector 101, a measuring unit 103, a normal walking learning unit 105, a determination unit 107, a storage unit 109, a content providing unit 113, and a position information acquisition unit 115.

The oscillation detector 101 is a sensor that detects oscillation. For example, the oscillation detector 101 may be any one of an acceleration sensor, a gyro sensor and an atmospheric pressure sensor. The oscillation detector 101 can supply detected oscillation detection data to the measuring unit 103.

The measuring unit 103 has a function of measuring amplitude and pitch of the oscillation detection data acquired by the oscillation detector 101. It is to be noted that the measuring unit 103 is an example of an acquisition unit that acquires the amplitude and pitch of the oscillation detection data. Once the measuring unit 103 has measured amplitude and pitch of the oscillation detection data acquired by the oscillation detector 101, the measuring unit 103 can supply the measured amplitude and pitch to the normal walking learning unit 105 and the determination unit 107.

The normal walking learning unit 105 has a function of learning the amplitude and pitch of the oscillation detection data during normal walking of the user of the terminal apparatus 100. For example, the normal walking learning unit 105 can calculate average amplitude and pitch values of the oscillation detection data of the past, which was obtained when it was determined that the user was normally walking, and can thereby supply the amplitude and pitch values during normal walking to the determination unit 107. Note that it is desirable that the oscillation detection data for use in this case is data of a vertical direction that tends to include an influence of walking.

The determination unit 107 has a function of determining whether or not the user is moving at a velocity faster than normal based on a difference between amplitude and pitch values of the oscillation detection data supplied from the measuring unit 103 and amplitude and pitch values during normal walking which is calculated by the normal walking learning unit 105 based on the oscillation detection data of the past. When it has been determined that the user is moving in a velocity faster than normal, the determination unit 107 can further determine whether the user is in the state of jogging or in the state of being in a hurry.

Various criteria can be considered for the determination unit 107 to determine whether the user is in the state of jogging or in the state of being in a hurry. Examples of the criteria include the followings. For example, the determination unit 107 may determine whether the user is in the state of jogging or in the state of being in a hurry based on date and time at present. For example, the determination unit 107 may determine that the user is in the state of being in a hurry if it is a commuting time zone on weekdays. When it has been determined by using a result of behavior recognition or action prediction that the user is during commuting to work or commuting to school, the determination unit 107 may determine that the user is in the state of being in hurry. The action prediction is to predict a current action of the user from the past action history. The action prediction may use schedule information of the user. For example, when it can be determined, from the schedule and the current position information, that the user is going to a destination described in the schedule, it is determined that the user is performing an action described in the schedule. In this case, if “jogging” or the like is described in the schedule, the determination unit 107 can determine that the user is in the state of jogging. If “visit customer” and the like is described in the schedule, the determination unit 107 may determine that the user is in the state of being in a hurry. The determination unit 107 may also determine whether the user is in the state of jogging or in the state of being in a hurry based on current position information acquired by the position information acquisition unit 115. For example, when the user is in a park or in a jogging course, the determination unit 107 may determine that the user is in the state of jogging. When the user is in a station premise, a building and the like in particular, the determination unit 107 may determine that the user is in the state of being in a hurry. The determination unit 107 may also determine whether the user is in the state of jogging or in the state of being in a hurry based on regularity of a waveform of the oscillation detection data. The determination unit 107 may determine that the user is in the state of being in a hurry when the waveform of the oscillation detection data is irregular. The determination unit 107 may also determine that the user is in the state of jogging when the waveform of the oscillation detection data is not uneven but even.

The determination unit 107 may supply a determination result to the content providing unit 113 if the content providing unit 113 is configured to select content depending on the determination result. It is to be noted that the determination unit 107 may store the determination result in a storage unit 109 inside the terminal apparatus 100. In this case, if it has been determined, for example, that the user is in the state of being in a hurry, the determination unit 107 may store, in the storage unit 109, determined time in association with the position information of the terminal apparatus 100 supplied from the position information acquisition unit 115. The stored information may be treated, for example, as one of the stressors in a life log of the user.

The storage unit 109 is a data storage device and may include a storage medium, a recording device that records data in a storage medium, a reading device that reads data from a storage medium, and a deleting device that deletes data recorded in a storage medium. Here, for example, a non-volatile memory such as a flash memory, a magnetoresistive random access memory (MRAM), a ferroelectric random access memory (FeRAM), a phase change random access memory (PRAM), or an electronically erasable and programmable read-only memory (EEPROM), or a magnetic recording medium such as a hard disk drive (HDD) may be used as the storage medium. For example, the storage unit 109 can store the date and time, when it has been determined that the user is in the state of being in a hurry, in association with the position information as described above.

The content providing unit 113 has an output function such as a display unit and an audio output unit so that content can be provided to the user. Here, the content is a concept including, for example, audio data such as music, lectures, and radio programs, video data such as movies, television programs, video programs, photographs, documents, pictures, and diagrammatic charts, games and software, start of an application and push notifications from an application. It is to be noted that the content providing unit 113 may have a function of selecting content based on the state of the user determined by the determination unit 107. The content providing unit 113 may also change frequency of providing the content to the user depending on the determination result of the determination unit 107. For example, there is a function of push-notifying recommendations to the user and notification of arrival of information through applications or the like. For the user who is in the state of being in a hurry, interesting information at that moment is limited. Accordingly, when it has been determined that the user is in the state of being in a hurry, it is desirable to reduce frequency of push notifications of an application with low urgency.

When it has been determined that the user is in the state of being in a hurry, it is preferable that the content providing unit 113 provides information that the user needs in the state of being in a hurry. For example, in this case, the content providing unit 113 may provide schedule information of the user. When the user is going to a station or a bus stop, the content providing unit 113 may provide timetables of electric cars or buses, or line information thereof. When it has been determined that the user is in the state of being in a hurry, the content providing unit 113 may provide a congested state around a current position of the user.

When it has been determined that the user is in the state of jogging, the content providing unit 113 may select and provide music with beats suitable for jogging to the user. The content providing unit 113 can also start an application relating to jogging. Or alternatively, the content providing unit 113 may display an icon for starting the jogging-related application on a top screen of the terminal apparatus 100.

The position information acquisition unit 115 has a function of acquiring current position information of the terminal apparatus 100. The position information acquisition unit 115 may have a function of acquiring, for example, position information based on positioning by global positioning system (GPS), position information based on Wi-Fi positioning, position information based on positioning by indoor messaging system (IMES), position information based on the location of a base station of a mobile phone, or relative position information based on a detection value of a sensor. Among these positioning functions, a plurality of functions may be possessed in combination. A description is now given of an example of the configuration of the position information acquisition unit 115 with reference to FIG. 2. FIG. 2 shows an example of the position information acquisition unit 115 having a function of GPS positioning and a function of relative position positioning with a sensor.

The position information acquisition unit 115 mainly includes a GPS antenna 221, a GPS processing unit 223, a triaxial geomagnetic sensor 229, a triaxial acceleration sensor 231, a triaxial gyro sensor 233, an advancing direction calculation unit 139, a walking velocity calculation unit 140, a relative position calculation unit 142, an atmospheric pressure sensor 235, an altitude calculation unit 144, and a position information generation unit 145.

The GPS antenna 221 is an example of an antenna that receives signals from GPS satellites. The GPS antenna 221 can receive GPS signals from a plurality of GPS satellites and input the received GPS signal into the GPS processing unit 221.

The GPS processing unit 223 has a function as a calculating unit that calculates position information based on the signals received from the GPS satellites. The GPS processing unit 223 calculates the current position information based on the plurality of GPS signals input from the GPS antenna 221 and outputs the calculated current position information of the terminal apparatus 200. Specifically, the GPS processing unit 223 calculates the position of each GPS satellite based on trajectory data of the GPS satellite and calculates the distance between each GPS satellite and the terminal apparatus 100 based on a time difference between transmission and reception times of the GPS signal. Then, the current three-dimensional position can be calculated based on the calculated position of each GPS satellite and the distance between each GPS satellite and the terminal apparatus 100. Here, the trajectory data of the GPS satellite may be included in the GPS signal. Furthermore, the trajectory data of the GPS satellite may be data which is acquired from an external server via a communication unit.

The triaxial geomagnetic sensor 229 is a sensor that detects acceleration as a voltage value. The triaxial geomagnetic sensor 229 detects each of geomagnetism data Mₓ in an X axis direction, geomagnetism data M_{y} in a Y axis direction, and geomagnetism data M_{z} in a Z axis direction. For example, the X axis may herein be defined as a longitudinal direction of a display screen of the terminal apparatus 100, the Y axis as a shorter side direction of the display screen, and the Z axis as a direction orthogonal to the X axis and the Y axis. The triaxial geomagnetic sensor 229 can supply detected geomagnetism data to the advancing direction calculation unit 139.

The triaxial acceleration sensor 231 is a sensor that detects acceleration as a voltage value. The triaxial acceleration sensor 231 may detect each of the acceleration αₓ in the X axis direction, the acceleration a, in the Y axis direction, and the acceleration A_{Z} the Z axis direction. The triaxial acceleration sensor 231 can supply the detected acceleration data to the advancing direction calculation unit 139 and the walking velocity calculation unit 140.

The triaxial gyro sensor 233 is a sensor that detects velocity (angular velocity) having a variable rotation angle as a pressure value. The triaxial gyro sensor 233 detects each of a roll rate ωₓ which is an angular velocity around the X axis, a pitch rate ω_{y} which is an angular velocity around the Y axis, and a yaw rate ω, which is an angular velocity around the Z axis. The triaxial gyro sensor 233 can supply detected angular velocity data to the advancing direction calculation unit 139.

The advancing direction calculation unit 139 has a function of calculating an advancing direction θ based on a vibrating direction of the acceleration and geomagnetism during walking. In this case, a detection value of the triaxial geomagnetic sensor 229 includes an error caused by a magnetic field environment. Accordingly, the advancing direction calculation unit 139 can appropriately correct the geomagnetism data detected by the triaxial geomagnetic sensor 229 with use of the angular velocity data detected by the triaxial gyro sensor 233, as necessary.

The walking velocity calculation unit 140 has a function of calculating a moving distance by multiplication of the number of steps and a stride and calculating a walking velocity V based on the moving distance and time taken for movement. The walking velocity calculation unit 140 can supply the calculated walking velocity V to the relative position calculation unit 142.

The relative position calculation unit 142 has a function of calculating an amount of change from a previously calculated position to a current position based on the velocity V calculated by the walking velocity calculation unit 140 and the advancing direction θ calculated by the advancing direction calculation unit 139. The relative position calculation unit 142 can supply information on the relative position calculated herein to the position information generation unit 145.

The atmospheric pressure sensor 235 is a sensor having a function of detecting a surrounding pressure as a voltage value. For example, the atmospheric pressure sensor 235 detects a pressure at a sampling frequency of 1 Hz and supplies the detected pressure data to the altitude calculation unit 144.

The altitude calculation unit 144 can calculate a current altitude of the terminal apparatus 100 based on the pressure data inputted from the atmospheric pressure sensor 235, and supply the calculated altitude data to the position information generation unit 145.

The position information generation unit 145 has a function of generating current position information of the terminal apparatus 100 based on absolute position information by GPS positioning supplied from the GPS processing unit 223, an advancing direction of the user supplied from the advancing direction calculation unit 139, relative position information supplied from the relative position calculation unit 142, and altitude data supplied from the altitude calculation unit 144. For example, when absolute position information is supplied from the GPS processing unit 223, the position information generation unit 145 may use the absolute position information as the current position information. When absolute position information is not supplied from the GPS processing unit 223, the position information generation unit 145 may use the position information based on the relative position supplied from position calculation unit 142 as the current position information. Or alternatively, the position information generation unit 145 may use the absolute position information in suitable combination with the relative position information. Moreover, the position information generated by the position information generation unit 145 may include advancing direction and altitude data of the user.

Examples of the function of the terminal apparatus 100 have hitherto been described with reference to FIGS. 1 and 2. The above-described respective constituent elements may be configured using general units or circuits or may be configured by hardware specialized for the functions of the respective constituent elements. Further, the functions of the respective constituent elements may be performed by reading a control program, which describes a processing order in which the functions are realized by an arithmetic device such as a central processing unit (CPU), from a storage medium such as a read-only memory (ROM) or a random access memory (RAM), which stores the control program, analyzing the control program, and executing the control program. Accordingly, a configuration to be appropriately used may be modified in accordance with a technical level at which this embodiment is realized.

A computer program configured to realize the functions of the terminal apparatus 100 according to the above-described embodiment may be created and mounted on a personal computer or the like. Further, a computer readable recording medium that stores the computer program may be provided. Examples of the recording medium include a magnetic disk, an optical disc, a magneto-optical disc, and a flash memory. Furthermore, the computer program may be delivered via a network or the like without use of a recording medium.

### 3. Hardware Configuration Example

The terminal apparatus 100 according to one embodiment of the present disclosure described in the foregoing may appropriately select a configuration to be used in accordance with a technical level at which this embodiment is realized as described before. A description is herein given of an example of a hardware configuration for realizing the functions of the terminal apparatus 100. It is to be noted that the hardware configuration described herein is merely an example and some of the constituent elements may be omitted and added.

For example, the terminal apparatus 100 includes a GPS antenna 221, a GPS processing unit 223, a communication antenna 225, a communication processing unit 227, a geomagnetic sensor 229, an acceleration sensor 231, a gyro sensor 233, an atmospheric pressure sensor 235, an A/D (Analog/Digital) conversion unit 237, a central processing unit (CPU) 239, a read-only memory (ROM) 241, a random access memory (RAM) 243, an operation unit 247, a display unit 249, a decoder 251, a speaker 253, an encoder 255, a microphone 257, and a storage unit 259.

The GPS antenna 221 is an example of an antenna that receives signals from positioning satellites. The GPS antenna 221 can receive GPS signals from a plurality of GPS satellites and input the received GPS signal into the GPS processing unit 223.

The GPS processing unit 223 is an example of a calculating unit that calculates position information based on the signals received from the positioning satellites. The GPS processing unit 223 calculates the current position information based on the plurality of GPS signals input from the GPS antenna 221 and outputs the calculated position information. Specifically, the GPS processing unit 223 calculates the position of each GPS satellite based on trajectory data of the GPS satellite and calculates the distance between each GPS satellite and the terminal apparatus 100 based on a time difference between transmission and reception times of the GPS signal. Then, the current three-dimensional position can be calculated based on the calculated position of each GPS satellite and the distance between each GPS satellite and the terminal apparatus 100. Further, the trajectory data of the GPS satellite used here may be included in, for example, the GPS signal. Furthermore, the trajectory data of the GPS satellite may be acquired from an external server via the communication antenna 225.

The communication antenna 225 is an antenna that has a function of receiving a communication signal via, for example, a portable communication network or a wireless local area network (LAN) communication network. The communication antenna 225 can supply the received signal to the communication processing unit 227.

The communication processing unit 227 has a function of performing various kinds of signal processing on the signal supplied from the communication antenna 225. The communication processing unit 227 can supply a digital signal generated from the supplied analog signal to the CPU 239.

The triaxial geomagnetic sensor 229 is a sensor that detects geomagnetism as a voltage value. The geomagnetic sensor 229 may be a triaxial geomagnetic sensor which detects geomagnetism in each of the X, Y and X axis directions. For example, the X axis may herein be defined as a longitudinal direction of a display screen of the terminal apparatus 100, the Y axis as a shorter side direction of the display screen, and the Z axis as a direction orthogonal to the X axis and the Y axis. The geomagnetic sensor 229 supplies the detected geomagnetism data to the A/D conversion unit 237.

The acceleration sensor 231 is a sensor that detects acceleration as a voltage value. The acceleration sensor 231 may be a triaxial acceleration sensor that detects each of the accelerations in the X, Y, and Z axis directions. The acceleration sensor 231 can supply the detected acceleration data to the A/D conversion unit 237.

The gyro sensor 233 may be a kind of a measuring device that detects an angle or an angular velocity of an object. The gyro sensor 233 may preferably be a triaxial gyro sensor that detects a change angle (angular velocity) of a rotation angle as a voltage value around the X, Y, and Z axes. The gyro sensor 833 can supply the detected angular velocity data to the A/D conversion unit 237.

The atmospheric pressure sensor 235 is a sensor that detects a surrounding pressure as a voltage value. The atmospheric pressure sensor 235 can detect a pressure at a predetermined sampling frequency and supply the detected pressure data to the A/D conversion unit 237.

The A/D conversion unit 237 has a function of converting an inputted analog signal to a digital signal and outputting the digital signal. For example, the A/D conversion unit 237 is a conversion circuit that converts an analog signal into a digital signal. It is to be noted that the A/D conversion unit 237 may be built in each sensor.

The CPU 239 functions as an arithmetic device and a control device to control all of the operating processes in the terminal apparatus 100 in accordance with various kinds of programs. The CPU 239 may be a microprocessor. The CPU 239 can realize various functions in accordance with various kinds of programs. For example, the CPU 239 may function as a direction calculation unit that detects an attitude angle based on the acceleration data detected by the acceleration sensor 231 and calculates a direction by using the attitude angle and the geomagnetism data detected by the geomagnetic sensor 229. The CPU 239 may function as a velocity calculation unit that calculates a moving velocity of the terminal apparatus 100 based on the acceleration data detected by the acceleration sensor 231 and the angular velocity data detected by the gyro sensor 233. The CPU 239 may also function as an altitude calculation unit that calculates altitude of the current position based on pressure data detected by the atmospheric pressure sensor 235.

The ROM 241 can store programs, calculation parameters, or the like used by the CPU 239. The RAM 243 can temporarily store programs used in execution of the CPU 239, or parameters or the like appropriately changed in the execution.

The operation unit 247 has a function of generating an input signal used for a user to perform a desired operation. The operation unit 247 may include an input unit, such as a touch panel, a mouse, a keyboard, a button, a microphone, a switch, or a lever, with which a user inputs information and an input control circuit configured to generate an input signal based on the input of the user and output the input signal to the CPU 239.

The display unit 249 is an example of an output device and may be a display device such as a liquid crystal display (LCD) device or an organic light emitting diode (OLED) display device. The display unit 249 can supply information by displaying a screen for a user.

The decoder 251 has a function of performing decoding, analog conversion, or the like on input data under the control of the CPU 239. The decoder 251 performs the decoding, the analog conversion, and the like on audio data input via, for example, the communication antenna 225 and the communication processing unit 227 and outputs an audio signal to the speaker 253. The speaker 253 can output audio based on the audio signal supplied from the decoder 251.

The encoder 255 has a function of performing digital conversion, encoding, or the like on input data under the control of the CPU 239. The encoder 255 can perform the digital conversion, the encoding, and the like on an audio signal input from the microphone 257 and output the audio data. The microphone 257 can collect audio and output the audio as an audio signal.

The storage unit 259 is a data storage device and may include a storage medium, a recording device that records data in a storage medium, a reading device that reads data from a storage medium, and a deleting device that deletes data recorded in a storage medium. Here, for example, a non-volatile memory such as a flash memory, a magnetoresistive random access memory (MRAM), a ferroelectric random access memory (FeRAM), a phase change random access memory (PRAM), or an electronically erasable and programmable read-only memory (EEPROM), or a magnetic recording medium such as a hard disk drive (HDD) may be used as the storage medium. For example, the storage unit 259 can store a map DB 261 and the like. The map DB 263 may include various kinds of information associated with position information, such as point of interest (POI) information, altitude information, and traffic information. It is to be noted that the map DB 263 is included in the terminal apparatus 100 in this case, though the present technology is not limited to the example disclosed. The map DB 261 may be included in an external device. The terminal apparatus 100 may be configured to be able to acquire various kinds of information associated with the position information by appropriately accessing to the map DB 261 included in an external device. The Map DB 261 may also be configured to appropriately acquire map information around the current position from an external device, as necessary.

### 4. Oscillation Detection Data

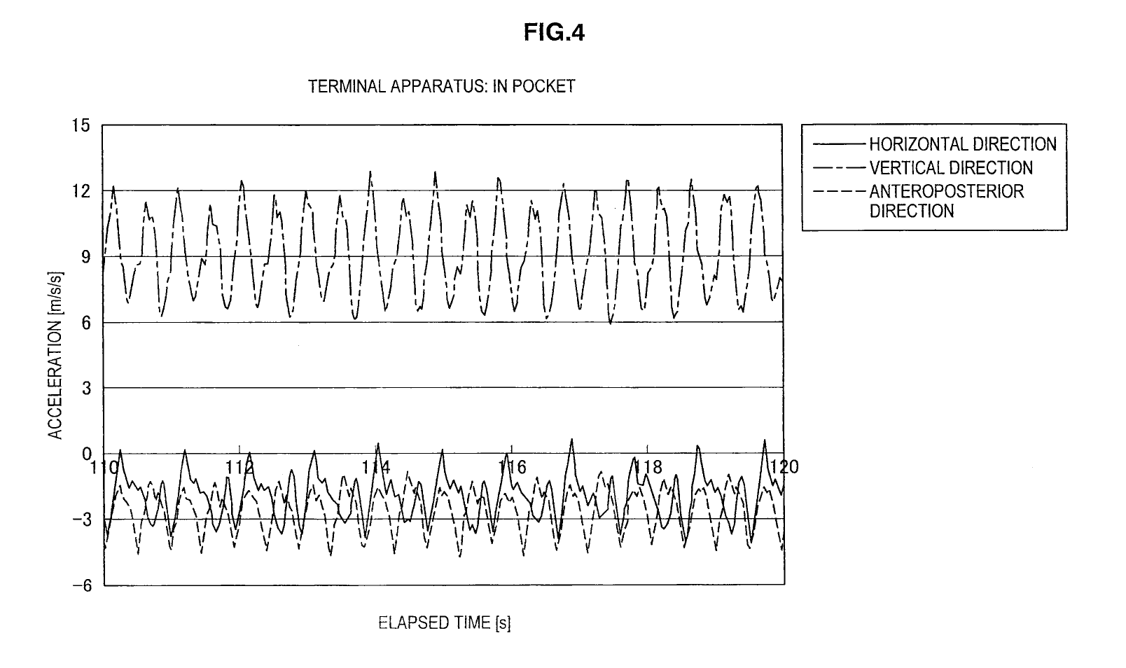

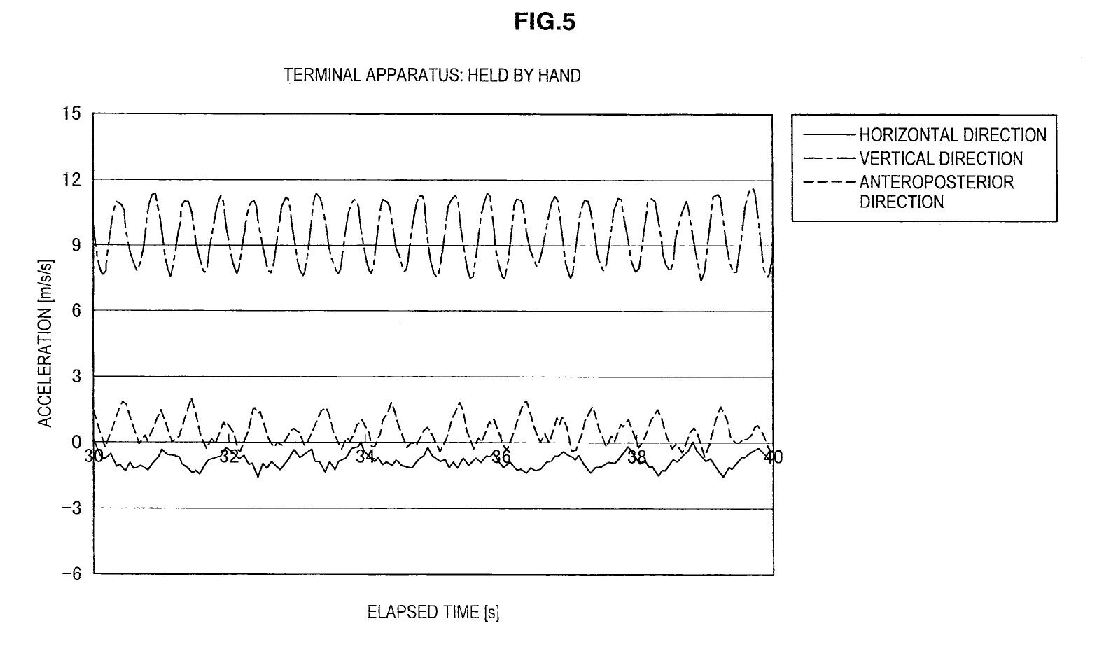

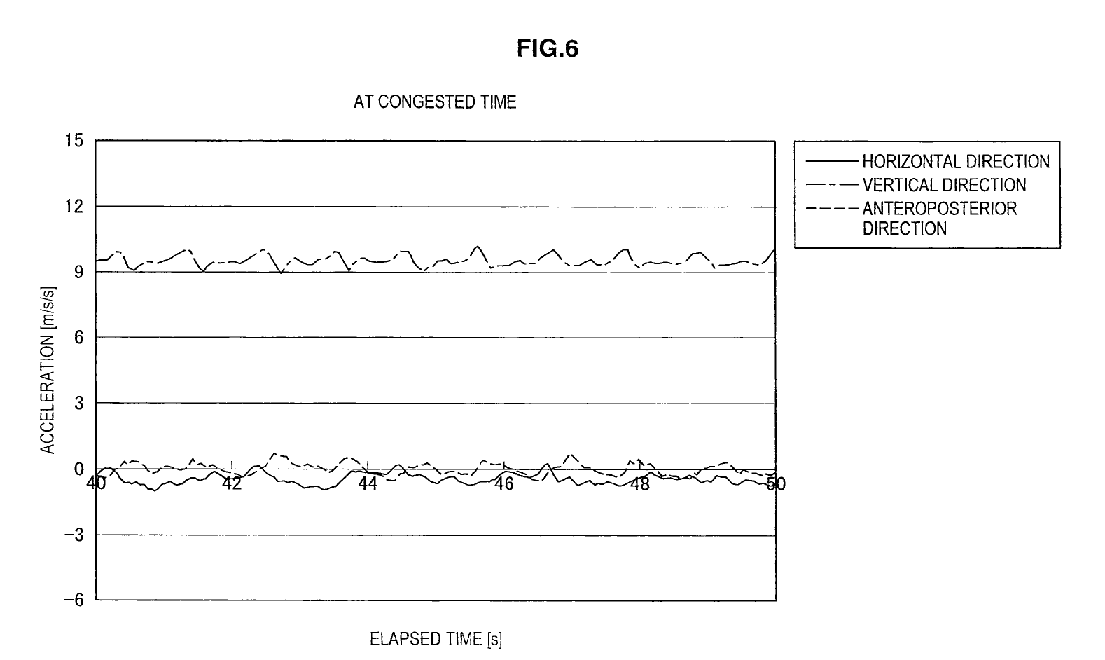

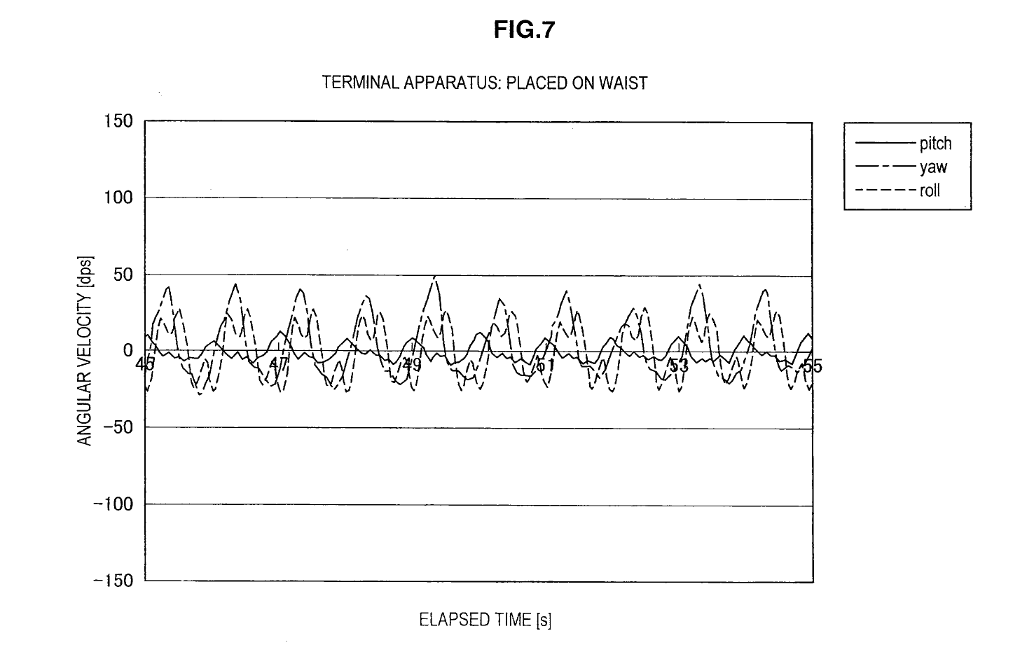

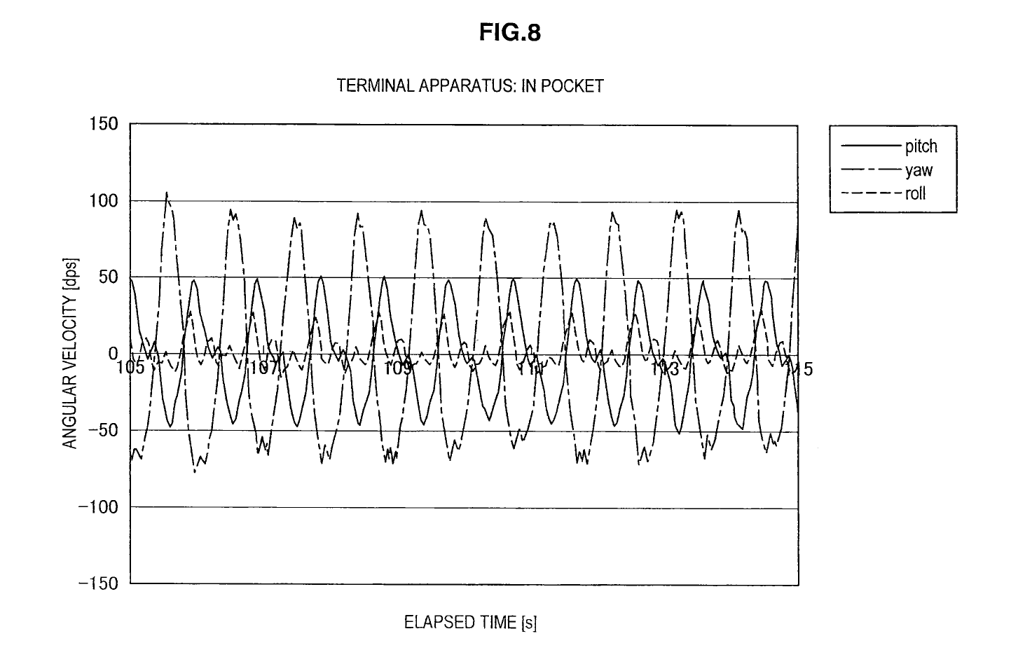

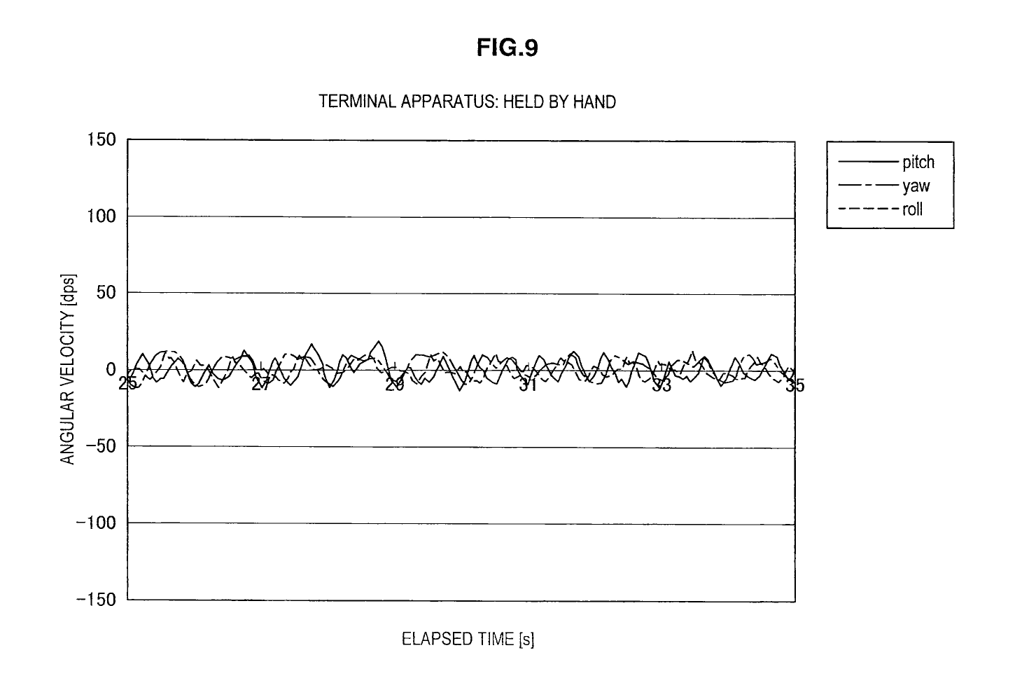

A consideration is now given to the detail of oscillation detection data supplied from the oscillation detector 101 with reference to FIGS. 4 to 9. FIG. 4 is a graph view showing an example of oscillation detection data (detected by an acceleration sensor) at a normal time when the terminal apparatus is put in a pocket and carried around. FIG. 5 is a graph view showing an example of oscillation detection data (detected by an acceleration sensor) at a normal time when the terminal apparatus is held by hand and carried around. FIG. 6 is a graph view showing an example of oscillation detection data (detected by an acceleration sensor) at a congested time. FIG. 7 is a graph view showing an example of oscillation detection data (detected by a gyro sensor) at a normal time when the terminal apparatus is placed on the waist. FIG. 8 is a graph view showing an example of oscillation detection data (detected by a gyro sensor) at a normal time when the terminal apparatus is put in a pocket and carried around. FIG. 9 is a graph view showing an example of oscillation detection data (detected by a gyro sensor) at a normal time when the terminal apparatus is held by hand and carried around.

FIGS. 4 to 6 respectively show oscillation detection data detected with use of an acceleration sensor in the case where the terminal apparatus 100 is put in a pocket and carried around, in the case where the terminal apparatus 100 is held by hand and carried around, and in the case of a congested time. In this regard, among the case where the terminal apparatus 100 is put in a pocket and carried around and the case where the terminal apparatus 100 is held by hand and carried around, amplitude of oscillation detection data is larger in the case where the terminal apparatus 100 is put in a pocket and carried around. However, with reference to FIG. 6, a difference between the amplitude of oscillation detection data of FIG. 4 and the amplitude of oscillation detection data of FIG. 6 and a difference between the amplitude of oscillation detection data of FIG. 5 and the amplitude of oscillation detection data of FIG. 6 are larger than a difference between the amplitude of oscillation detection data of FIG. 4, and the amplitude of oscillation detection data of FIG. 5. Therefore, in this case, the oscillation detection data can be used for state determination regardless of how the terminal apparatus 100 is carried around.

With reference to FIGS. 4 to 6, the oscillation detection data detected by an acceleration sensor, and vertical (vertical-direction) oscillation detection data in particular, are less likely to be influenced by how the terminal apparatus 100 is carried around. Moreover, since an influence of a walking pitch of the user is more likely to be reflected on the vertical oscillation detection data, it is desirable that the determination unit 107 determines the state of the user based on amplitude and pitch values of the vertical oscillation detection data.

Further, FIGS. 7 to 9 respectively show oscillation detection data detected with use of a gyro sensor in the case where the terminal apparatus 100 is placed on the waist, in the case where the terminal apparatus 100 is put in a pocket and carries around, and in the case where the terminal apparatus 100 is held by hand and carried around. In FIGS. 7 to 9, the amplitude of the oscillation detection data detected with use of a gyro sensor is largely varied depending on how the terminal apparatus 100 is carried around. Accordingly, when the determination unit 107 performs determination based on the oscillation detection data detected with use of a gyro sensor, it is desirable to perform determination by using not the amplitude but the pitch of oscillation detection data. Moreover, among the oscillation detection data detected with use of a gyro sensor, oscillation detection data indicating a yaw angle is less likely to be influenced by how the terminal apparatus 100 is held and an influence of the walking pitch of the user is more likely to be reflected thereon (one cycle for two steps). Accordingly, it is preferable that the determination unit 107 implements determination based on a pitch value of the oscillation detection data that indicates a yaw angle.

Moreover, the oscillation detection data used for determination may be detected by an atmospheric pressure sensor. At present, the resolution and sampling period of the atmospheric pressure sensor are still not sufficient enough to measure the walking pitch. However, by using an atmospheric pressure sensor which has a performance high enough to detect vertical movement generated by walking, it becomes possible to use oscillation detection data detected by the atmospheric pressure sensor for determination.

It is to be noted that only a bandwidth (for example, 1.5 to 3.5 Hz) for use in detecting the walking pitch is preferably extracted by using a filter so as to remove noise included in the oscillation detection data acquired with use of the atmospheric pressure sensor. For example, the pressure is largely varied by simple actions such as passing by a vehicle and opening and closing of a window. Accordingly, processing of removing such a noise component is important in the case of using the oscillation detection data acquired by the atmospheric pressure sensor for determination.

### 5. Operation Example

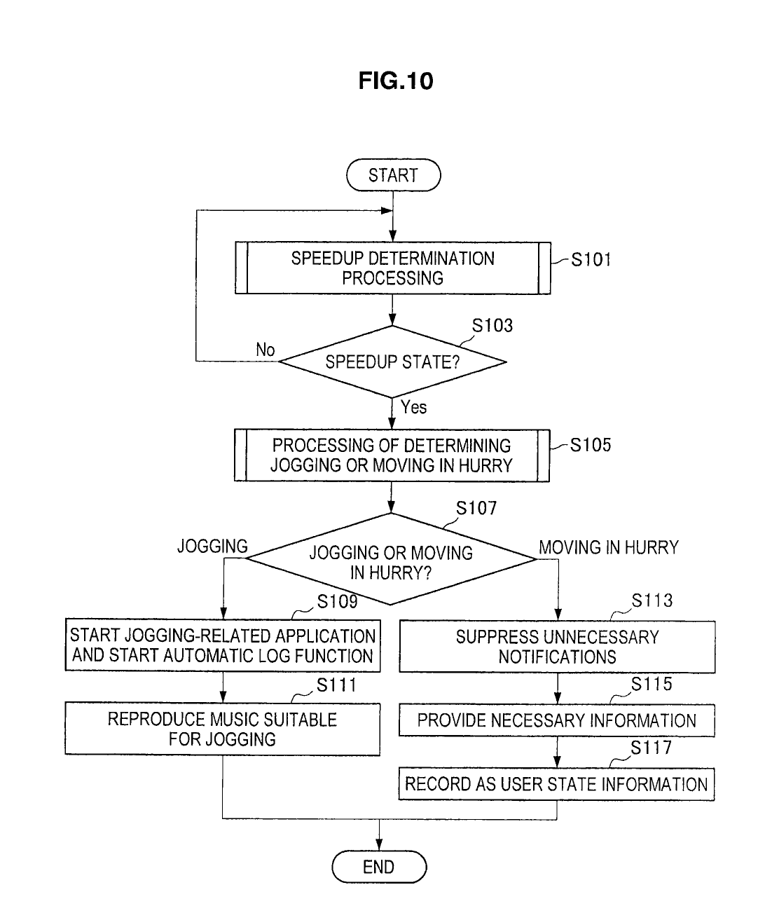

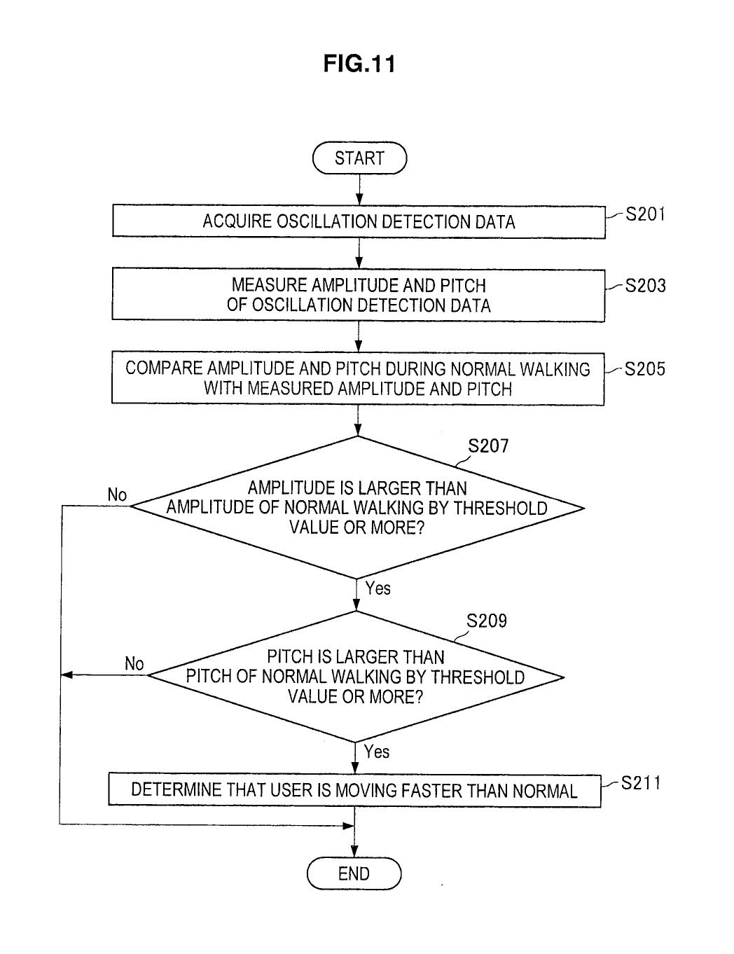

A description is now given of operation of the terminal apparatus 100 according to the present embodiment with reference to FIGS. 10 and 11. FIG. 10 is a flow chart showing operation of the terminal apparatus according to the embodiment. FIG. 11 is a flow chart showing a flow of speedup determination processing of the terminal apparatus according to the embodiment.

The terminal apparatus 100 first executes processing of determining whether or not a user is in a speedup state of moving at a velocity faster than that of normal walking (S101). The speedup state, which herein refers to the state where the user is moving on foot at a velocity faster than that of normal walking, is a concept including a state of jogging and a state of moving quickly. The determination unit 107 determines whether a determination result indicates the speedup state (S103). When it has been determined that the user is not in the speedup state in Step S103, then the routine returns to step S101. On the contrary, if it has been determined that the user is in the speedup state, the determination unit 107 then determines whether the user is in the state of jogging or in the state of moving in a hurry (S107).

When it has been determined in step S107 that the user is in the state of jogging, the content providing unit 113 starts a jogging-related application and starts an automatic log function (S109). The content providing unit 113 also selects music suitable for jogging and starts reproduction of the selected music (S111).

Contrary to this, if it has been determined in step S107 that the user is moving in a hurry, the content providing unit 113 suppresses unnecessary notifications (S113). More specifically, broadcasting frequency of the contents is reduced. The content providing unit 113 then provides information needed in the state where the user is in a hurry (S115). The determination unit 107 can also record that the user is in the state of moving in a hurry as one of stress elements of a life log of the user (S117).

A description is herein given of the detail of the speedup determination processing (S101) with reference to FIG. 11. First, the oscillation detector 101 acquires oscillation detection data (S201). Then, the measuring unit 103 measures amplitude and pitch of the oscillation detection data (S203). The determination unit 107 then compares size relation between the amplitude and pitch during normal walking and the amplitude and pitch measured by the measuring unit 103 (S205).

The determination unit 107 then determines whether or not an amplitude value supplied from the measuring unit 103 is larger than that of normal time by a threshold value or more (S207). When the amplitude value is larger than that of normal time by a threshold value or more, the determination unit 107 then determines whether or not a pitch value supplied from the measuring unit 103 is larger than that of normal time by a threshold value or more (S209). When it has been determined that the pitch value is larger than that of normal time by a threshold value or more, then the determination unit 107 determines that the user is in the speedup state of moving faster than normal (S211).

The preferred embodiments of the present technology have been described above with reference to the accompanying drawings, whilst the present technology is not limited to the above examples, of course. A person skilled in the art may find various alternations and modifications within the scope of the appended claims, and it should be understood that they will naturally come under the technical scope of the present technology.

For example, in the present embodiment, the congestion determination unit 107 determined a congestion degree by determining whether or not the apparatus is in the congested state by using a threshold value. However, the present technology is not limited to the example disclosed. For example, pitch and amplitude at a normal time may be compared with pitch and amplitude at the current time, and the congestion degree may be determined in stages depending on a value of the difference or with a continuous value. The congestion determination unit 107 may also store an oscillation at a normal time as two-dimensional distribution of amplitude and pitch (for example, mean value and variance), and to stochastically determine the congestion degree depending on how much a the current oscillation is deviated from distribution at a normal time.

Although congestion determination was performed based on pitch and amplitude values of the oscillation detection data, the present technology is not limited to the example disclosed. For example, the congestion determination may be performed based only on the pitch. For example, when the amplitude of oscillation detection data is less likely to be dependent on how the terminal apparatus 100 is held, and an influence of the congestion degree is more likely to be reflected thereon, it is desirable to perform congestion determination by using an amplitude value in addition to the pitch value.

In the specification, the steps described in the flowchart include not only processes performed chronologically in the described order but also processes performed in parallel or separately even when the processes are not necessarily performed chronologically. Of course, the order of the steps processed chronologically may be changed appropriately, as necessary. For example, in the above-described embodiments, all of the steps S109, step S111, step S113, and step S115 are configured to be executed, though the present technology is not limited to the examples disclosed. Any one of or a plurality of these respective steps may be executed.

Additionally, the present technology may also be configured as below.

(1)

An information processing apparatus including:

an acquisition unit configured to acquire a pitch of walking from oscillation detection data; and

a determination unit configured to determine whether or not a user is moving at a velocity faster than normal based on a difference between the pitch acquired by the acquisition unit and a pitch during normal walking which is calculated based on the oscillation detection data of a past.

(2)

The information processing apparatus according to (1), wherein

the acquisition unit further acquires amplitude of the oscillation detection data, and

the determination unit determines whether or not the user is moving at a velocity faster than normal further based on a difference between the amplitude acquired by the acquisition unit and amplitude during normal walking which is calculated based on the oscillation detection data of the past.

(3)

The information processing apparatus according to (1) or (2), wherein

the acquisition unit acquires a pitch of walking from vertical oscillation detection data.

(4)

The information processing apparatus according to any one of (1) to (3), wherein

when the determination unit determines that the user is moving at a velocity faster than normal, the determination unit further determines whether the user is in a state of jogging or in a state of being in a hurry.

(5)

The information processing apparatus according to (4), wherein

the determination unit determines whether the user is jogging or is in a hurry based on a current date and time.

(6)

The information processing apparatus according to (4) or (5), wherein

when a result of behavior recognition or action prediction indicates commuting to work or commuting to school, the determination unit determines that the user is in the state of being in a hurry.

(7)

The information processing apparatus according to any one of (4) to (6), further including:

a position information acquisition unit configured to acquire current position information,

wherein the determination unit determines whether the user is in the state of jogging or in the state of being in a hurry based on the position information.

(8)

The information processing apparatus according to (7), wherein

when the position information indicates a place suitable for jogging, the determination unit determines that the user is in the state of jogging.

(9)

The information processing apparatus according to any one of (4) to (8), wherein

the determination unit determines whether the user is in the state of jogging or in the state of being in a hurry based on regularity of a waveform of the oscillation detection data.

(10)

The information processing apparatus according to any one of (1) to (9), further including:

a content providing unit configured to provide content to the user based on a determination result of the determination unit.

(11)

The information processing apparatus according to (10), wherein

when the determination unit determines that the user is in the state of being in a hurry, the content providing unit reduces frequency of push notifications of an application.

(12)

The information processing apparatus according to (11), wherein

the content providing unit decides frequency of the push notifications depending on urgency of the application.

(13)

The information processing apparatus according to any one of (10) to (12), wherein

when the determination unit determines that the user is in the state of being in a hurry, the content providing unit provides schedule information of the user.

(14)

The information processing apparatus according to (10), wherein

when the determination unit determines that the user is in the state of being in a hurry, the content providing unit provides a congestion state around a current position of the user.

(15)

The information processing apparatus according to the (10), wherein

when the determination unit determines that the user is in the state of being in a hurry,

the content providing unit provides information that guides a route to a destination of the user.

(16)

The information processing apparatus according to any one of (4) to (16), wherein

when the determination unit determines that the user is in the state of being in a hurry, the determination unit records that the user is in a state of stress.

(17)

The information processing apparatus according to any one of (10) to (16), wherein

when the determination unit determines that the user is in the state of jogging, the content providing unit selects music suitable for jogging and provides the music to the user.

(18)

The information processing apparatus according to any one of (10) to (17), wherein

when the determination unit determines that the user is in the state of jogging, the content providing unit starts an application relating to jogging.

(19)

The information processing apparatus according to the (10), wherein

when the determination unit determines that the user is in the state of jogging,

the content providing unit displays an icon for starting the jogging-related application on a top screen.

(20)

An information processing method including:

acquiring a pitch of walking from oscillation detection data; and

determining whether or not a user is moving at a velocity faster than normal based on a difference between the acquired pitch and a pitch during normal walking which is calculated based on the oscillation detection data of a past.

(21)

A program for causing a computer to function as an information processing apparatus, the information processing apparatus including

an acquisition unit configured to acquire a pitch of walking from oscillation detection data, and

a determination unit configured to determine whether or not a user is moving at a velocity faster than normal based on a difference between the pitch acquired by the acquisition unit and a pitch during normal walking which is calculated based on the oscillation detection data of a past.

(23)

A computer readable recording medium for having a program thereon, the program causing a computer to function as an information processing apparatus that includes

an acquisition unit configured to acquire a pitch of walking from oscillation detection data, and

a determination unit configured to determine whether or not a user is moving at a velocity faster than normal based on a difference between the pitch acquired by the acquisition unit and a pitch during normal walking which is calculated based on the oscillation detection data of a past.

(18) The information processing apparatus according to any one of the (10) to (17), wherein

when the determination unit determines that the user is in the state of jogging,

the content providing unit starts an application relating to jogging.

### REFERENCE SIGNS LIST

100 Terminal apparatus
101 Oscillation detector
103 Measuring unit
105 Normal walking learning unit
107 Congestion determination unit
109 Storage unit
113 Content providing unit
115 Position information acquisition unit

1. An information processing apparatus comprising:
an acquisition unit configured to acquire a pitch of walking from oscillation detection data; and
a determination unit configured to determine whether or not a user is moving at a velocity faster than normal based on a difference between the pitch acquired by the acquisition unit and a pitch during normal walking which is calculated based on the oscillation detection data of a past.

2. The information processing apparatus according to claim 1, wherein
the acquisition unit further acquires amplitude of the oscillation detection data, and
the determination unit determines whether or not the user is moving at a velocity faster than normal further based on a difference between the amplitude acquired by the acquisition unit and amplitude during normal walking which is calculated based on the oscillation detection data of the past.

3. The information processing apparatus according to claim 1, wherein
the acquisition unit acquires a pitch of walking from vertical oscillation detection data.

4. The information processing apparatus according to claim 1, wherein
when the determination unit determines that the user is moving at a velocity faster than normal, the determination unit further determines whether the user is in a state of jogging or in a state of being in a hurry.

5. The information processing apparatus according to claim 4, wherein
the determination unit determines whether the user is jogging or is in a hurry based on a current date and time.

6. The information processing apparatus according to claim 4, wherein
when a result of behavior recognition or action prediction indicates commuting to work or commuting to school, the determination unit determines that the user is in the state of being in a hurry.

7. The information processing apparatus according to claim 4, further comprising:
a position information acquisition unit configured to acquire current position information,
wherein the determination unit determines whether the user is in the state of jogging or in the state of being in a hurry based on the position information.

8. The information processing apparatus according to claim 7, wherein
when the position information indicates a place suitable for jogging, the determination unit determines that the user is in the state of jogging.

9. The information processing apparatus according to claim 4, wherein
the determination unit determines whether the user is in the state of jogging or in the state of being in a hurry based on regularity of a waveform of the oscillation detection data.

10. The information processing apparatus according to claim 4, further comprising:
a content providing unit configured to provide content to the user based on a determination result of the determination unit.

11. The information processing apparatus according to claim 10, wherein
when the determination unit determines that the user is in the state of being in a hurry, the content providing unit reduces frequency of push notifications of an application.

12. The information processing apparatus according to claim 11, wherein
the content providing unit decides frequency of the push notifications depending on urgency of the application.

13. The information processing apparatus according to claim 10, wherein
when the determination unit determines that the user is in the state of being in a hurry, the content providing unit provides schedule information of the user.

14. The information processing apparatus according to claim 10, wherein
when the determination unit determines that the user is in the state of being in a hurry, the content providing unit provides a congestion state around a current position of the user.

15. The information processing apparatus according to claim 4, wherein
when the determination unit determines that the user is in the state of being in a hurry, the determination unit records that the user is in a state of stress.

16. The information processing apparatus according to claim 10, wherein
when the determination unit determines that the user is in the state of jogging, the content providing unit selects music suitable for jogging and provides the music to the user.

17. The information processing apparatus according to claim 10, wherein
when the determination unit determines that the user is in the state of jogging, the content providing unit starts an application relating to jogging.

18. An information processing method comprising:
acquiring a pitch of walking from oscillation detection data; and
determining whether or not a user is moving at a velocity faster than normal based on a difference between the acquired pitch and a pitch during normal walking which is calculated based on the oscillation detection data of a past.

19. A program for causing a computer to function as an information processing apparatus, the information processing apparatus including
an acquisition unit configured to acquire a pitch of walking from oscillation detection data, and
a determination unit configured to determine whether or not a user is moving at a velocity faster than normal based on a difference between the pitch acquired by the acquisition unit and a pitch during normal walking which is calculated based on the oscillation detection data of a past.

20. A computer readable recording medium for having a program thereon, the program causing a computer to function as an information processing apparatus that includes
an acquisition unit configured to acquire a pitch of walking from oscillation detection data, and
a determination unit configured to determine whether or not a user is moving at a velocity faster than normal based on a difference between the pitch acquired by the acquisition unit and a pitch during normal walking which is calculated based on the oscillation detection data of a past.
